(19) United States
(12) Patent Application Publication
(10) Pub. No.: US 2007/0191045 A1
(43) Pub. Date: Aug. 16, 2007

(54) Method and system for synchronization procedures in a wide band CDMA network based on a sign metric

(76) Inventors: Mark Kent, Vista, CA (US); Louis Botha, San Diego, CA (US); Severine Catreux-Erceg, Cardiff, CA (US)

Correspondence Address: MCANDREWS HELD & MALLOY, LTD, 500 WEST MADISON STREET, SUITE 3400, CHICAGO, IL, 60661, US

(21) Appl. No.: 11/355,109

(22) Filed: Feb. 15, 2006

(51) Int. Cl. H04B 7/00; H04Q 7/20

(52) U.S. Cl. 455/522

(57) ABSTRACT

A method and system for synchronization procedures in a wide band CDMA (W-CDMA) network based on a sign metric may include calculating a sign metric of a downlink dedicated physical channel (DPCH) based on a plurality of transmit power control (TPC) bits received via the downlink dedicated physical channel, wherein a value of at least one of the plurality of TPC bits is not known when at least one of the plurality of TPC bits is received and the sign metric specifies an error associated with the plurality of TPC bits. The transmit circuitry may be controlled based on the calculated sign metric. The transmit circuitry may be disabled if the calculated sign metric of the plurality of TPC bits is above a first channel threshold. The transmit circuitry may be enabled if the calculated sign metric of the plurality of TPC bits is below a second channel threshold.

### CROSS-REFERENCE TO RELATED APPLICATIONS/INCORPORATION BY REFERENCE

This application makes reference to:

U.S. application Ser. No. ______ (Attorney Docket No. 16915US01) filed on even date herewith;

U.S. application Ser. No. ______ (Attorney Docket No. 16999US01) filed on even date herewith; and

U.S. application Ser. No. ______ (Attorney Docket No. 17001US01) filed on even date herewith;

The above state application is hereby incorporated herein by reference in its entirety.

### FIELD OF THE INVENTION

Certain embodiments of the invention relate to wireless communication. More specifically, certain embodiments of the invention relate to a method and system for synchronization procedures in a wide band CDMA (W-CDMA) network based on a sign metric.

### BACKGROUND OF THE INVENTION

Mobile communications has changed the way people communicate and mobile phones have been transformed from a luxury item to an essential part of every day life. The use of mobile phones is today dictated by social situations, rather than hampered by location or technology. While voice connections fulfill the basic need to communicate, and mobile voice connections continue to filter even further into the fabric of every day life, the mobile Internet is the next step in the mobile communication revolution. The mobile Internet is poised to become a common source of everyday information, and easy, versatile mobile access to this data will be taken for granted.

Third generation (3G) cellular networks have been specifically designed to fulfill these future demands of the mobile Internet. As these services grow in popularity and usage, factors such as cost efficient optimization of network capacity and quality of service (QoS) will become even more essential to cellular operators than it is today. These factors may be achieved with careful network planning and operation, improvements in transmission methods, and advances in receiver techniques. To this end, carriers need technologies that will allow them to increase downlink throughput and, in turn, offer advanced QoS capabilities and speeds that rival those delivered by cable modem and/or DSL service providers. In this regard, networks based on wideband CDMA (WCDMA) technology may make the delivery of data to end users a more feasible option for today's wireless carriers.

The universal mobile telecommunications system (UMTS) is an adaptation of a 3G system, which is designed to offer integrated voice, multimedia, and Internet access services to portable user equipment. The UMTS adapts wideband CDMA (WCDMA) to support data transfer rates, which may be as high as 2 Mbits/s. One reason why WCDMA may support higher data rates is that WCDMA channels may have a bandwidth of 5 MHz versus the 200 kHz channel bandwidth in GSM.

In the case of a WCDMA downlink, multiple access interference (MAI) may result from inter-cell and intracell interference. The signals from neighboring base stations compose intercell interference, which is characterized by scrambling codes, channels and angles of arrivals different from the desired base station signal. Spatial equalization may be utilized to suppress inter-cell interference. In a synchronous downlink application, employing orthogonal spreading codes, intra-cell interference may be caused by multipath propagation. Due to the non-zero cross-correlation between spreading sequences with arbitrary time shifts, there is interference between propagation paths after despreading, causing MAI. The level of intra-cell interference depends strongly on the channel response. In nearly flat fading channels, the physical channels remain almost completely orthogonal and intra-cell interference does not have any significant impact on the receiver performance. Frequency selectivity is common for the channels in WCDMA networks.

Mobile networks allow users to access services while on the move, thereby giving end users freedom in terms of mobility. However, this freedom does bring uncertainties to mobile systems. The mobility of the end users causes dynamic variations both in the link quality and the interference level, sometimes requiring that a particular user change its serving base station. This process is known as handover (HO). Handover is the essential component for dealing with the mobility of end users. It guarantees the continuity of the wireless services when the mobile user moves across cellular boundaries.

WCDMA networks may allow a mobile handset to communicate with a multiple number of cell sites. This may take place, for example, for a soft-handoff from one cell site to another. Soft-handoffs may involve cell sites that use the same frequency bandwidth. On occasions, there may be handoffs from one cell site to another where the two cell sites use different frequencies. In these cases, the mobile handset may need to tune to the frequency of the new cell site. Additional circuitry may be required to handle communication over a second frequency of the second cell site while still using the first frequency for communicating with the first cell site. The additional circuitry may be an undesirable extra cost for the mobile handset.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for synchronization procedures in a WCDMA network based on a sign metric, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is an exemplary diagram illustrating a WCDMA handset communicating with two WCDMA base stations, in accordance with an embodiment of the invention.

FIG. 1B is a block diagram of an exemplary radio frame format of a downlink dedicated physical channel (DPCH), in accordance with an embodiment of the invention.

FIG. 1C is a graph illustrating the effect of a sign metric as an indicator of the quality of received signals on the DPCH, in accordance with an embodiment of the invention.

FIG. 2 is a block diagram illustrating one embodiment of the determination of a transmit power control (TPC) sign metric per radio link set in a WCDMA network, in accordance with an embodiment of the invention.

FIG. 3 is a block diagram illustrating another embodiment of the determination of a transmit power control (TPC) sign metric for a plurality of radio link sets in a WCDMA network, in accordance with an embodiment of the invention.

FIG. 4 is a block diagram illustrating another embodiment of the determination of a transmit power control (TPC) sign metric for a plurality of radio link sets in a WCDMA network, in accordance with an embodiment of the invention.

FIG. 5 is a block diagram illustrating another embodiment of the determination of a transmit power control (TPC) sign metric per radio link set in a WCDMA network, in accordance with an embodiment of the invention.

FIG. 6 is a block diagram illustrating a method for avoiding bouncing between in-sync and out-of-sync states, in accordance with an embodiment of the invention.

FIG. 7 is a flowchart illustrating exemplary steps for synchronization procedures in a WCDMA network based on a sign metric, in accordance with an embodiment of the invention.

### DETAILED DESCRIPTION OF THE INVENTION

A method and system for synchronization procedures in a WCDMA network based on sign-metric may comprise calculating a sign metric of a downlink dedicated physical channel (DPCH) based on a plurality of transmit power control (TPC) bits received via the downlink dedicated physical channel (DPCH). A value of at least one of the plurality of TPC bits is not known when at least one of the plurality of TPC bits is received and the sign metric specifies an error associated with the plurality of TPC bits. The uplink transmit circuitry may be controlled based on the calculated sign metric. The transmit circuitry may be disabled if the calculated sign metric of the plurality of TPC bits is above a first channel threshold. The transmit circuitry may be enabled if the calculated sign metric of the plurality of TPC bits is below a second channel threshold.

Due to the difficulties faced when non-linear channel equalizers are applied to the WCDMA downlink, detection of the desired physical channel with a non-linear equalizer may require implementing an interference canceller or optimal multi-user receiver. Both types of receivers may be prohibitively complex for mobile terminals and may require information not readily available at the mobile terminal. Alternatively, the total base station signal may be considered as the desired signal. However, non-linear equalizers rely on prior knowledge of the constellation of the desired signal, and this information is not readily available at the WCDMA terminal. The constellation of the total base station signal, that is, sum of all physical channels, is a high order quadrature amplitude modulation (QAM) constellation with uneven spacing. The spacing of the constellation changes constantly due to transmission power control (TPC) and possible power offsets between the control data fields, time-multiplexed to the dedicated physical channels. The constellation order may also frequently change due to discontinuous transmission (DTX). This makes an accurate estimation of the constellation very difficult.

Uplink power control (PC) is of paramount importance for CDMA-based systems because the capacity of such a system is a function of the interference level. The power transmitted by all active user equipments (UE) within a network may be controlled to limit interference levels and alleviate well-known problems such as the “near-far” effect. If there is more than one user active, the transmitted power of non-reference users is suppressed by a factor dependent on the partial cross-correlation between the code of the reference user and the code of the non-reference user. However, when a non-reference user is closer to the receiver than the reference user, it is possible that the interference caused by this non-reference user has more power than the reference user also referred to as the “near-far” effect.

There are two types of power-control techniques. Open-loop power-control where each user equipment measures its received signal power and adjusts its transmit power accordingly and closed-loop power-control where an active radio link (RL) measures the received signal power from all user equipments and simultaneously commands the individual user equipments to raise or lower their transmit uplink power such that the received signal-to-noise ratio (SNR) from all user equipments at the radio links is the same.

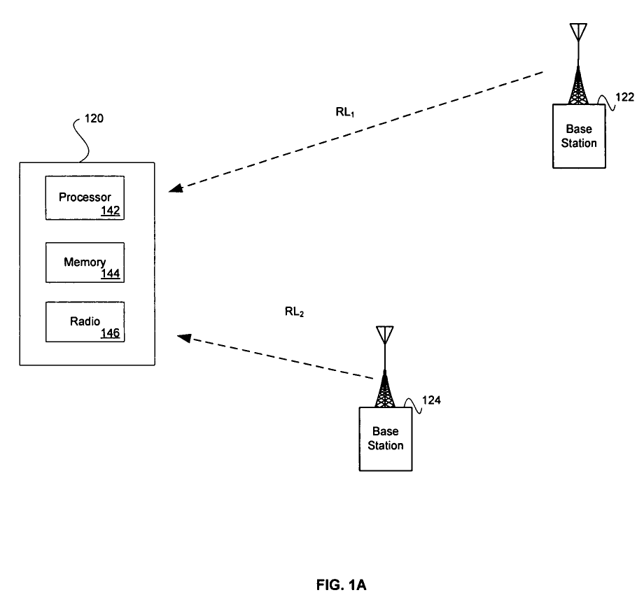

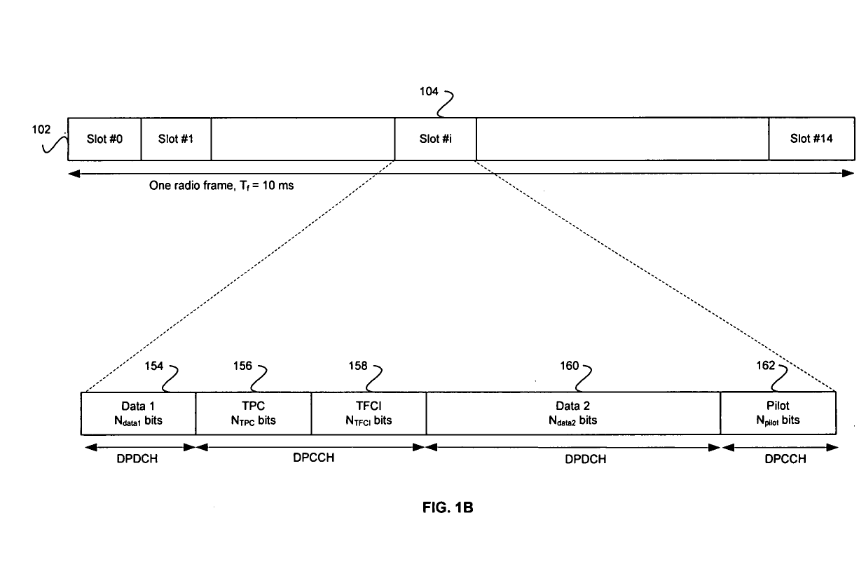

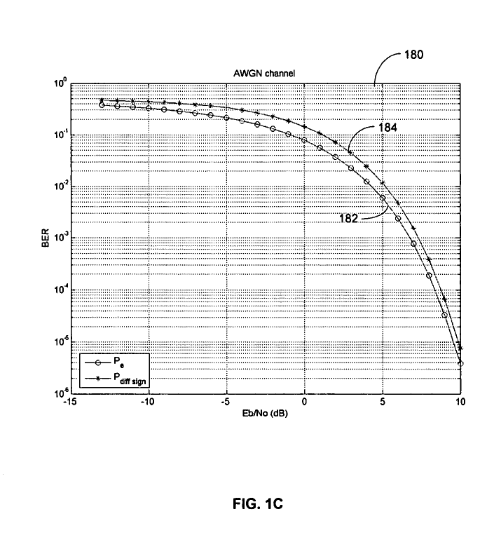

FIG. 1A is an exemplary diagram illustrating a WCDMA handset communicating with two WCDMA base stations, in accordance with an embodiment of the invention. Referring to FIG. 1A, there is shown a mobile handset or user equipment 120, a plurality of base stations BS 122 and BS 124 and a plurality of radio links (RL), RL₁ and RL₂ coupling the user equipment 120 with the base stations BS 122 and BS 124 respectively. The user equipment 120 may comprise a processor 142, a memory 144, and a radio 146.

The processor 142 may communicate and/or control a plurality of bits to/from the base stations BS 122 and BS 124. The memory 144 may comprise suitable logic, circuitry, and/or code that may store data and/or control information. The radio 146 may comprise transmit circuitry and/or receive circuitry that may be enabled to calculate a sign metric of a downlink dedicated physical channel (DPCH) based on a plurality of transmit power control (TPC) bits received via the downlink dedicated physical channel (DPCH), wherein the plurality of TPC bits are not known when they are received. The radio links that belong to the same radio link set broadcast the same values of transmit power control (TPC) bits. The radio links that belong to different radio link sets may broadcast different TPC bits. The user equipment 120 may receive TPC bits via multiple radio links, for example, RL₁ and RL₂ simultaneously. In a handover situation, the user equipment 120 may receive signals from multiple radio link sets simultaneously.

The WCDMA specification defines the physical random access channel (PRACH) for mobile phone uplinks and the acquisition indicator channel (AICH) for BTS downlinks. Communication is established when the user equipment 120 completes its search for a base station, for example, BS 122 and synchronizes its PRACH uplink signal with the BTS AICH downlink signal. When operating properly, the base station recognizes a PRACH preamble from the user equipment 120 and responds with an AICH to establish a communication link. The user equipment 120 may use the PRACH to transmit its setting of its open loop power control to the base station 122. Incorrect data in the PRACH preamble or problems with the signal quality may cause missed connections, disrupt the capacity of the cell or prevent response from the base station 122.

FIG. 1B is a block diagram of an exemplary radio frame format of a downlink dedicated physical channel (DPCH), in accordance with an embodiment of the invention. With reference to FIG. 1B there is shown a radio frame format 102, with a time period T_{f} equal to 10 ms, for example. The radio frame 102 may comprise a plurality of slots, for example, 15 slots. Each of the slots in the radio frame 102, for example, slot # i 104 may comprise a plurality of dedicated physical data channels (DPDCH) and a plurality of dedicated physical control channels (DPCCH). The time period of each slot in the radio frame 102, for example, time period of slot # i may be equal to 10*2^{k} bits, where k=0 . . . 7, for example.

The DPDCH is a type of downlink channel, which may be represented as an I/Q code multiplexed within each radio frame 102. The downlink DPDCH may be utilized to carry data, for example, data 1 154 comprising N_{data1} bits and data 2 160 comprising N_{data2} bits. There may be zero, one, or a plurality of downlink dedicated physical data channels on each radio link.

The DPCCH is a type of downlink channel, which may be represented as an I/Q code multiplexed within each radio frame 102. The downlink DPCCH may be utilized to carry control information generated at the physical layer. The control information may comprise a transmit power control (TPC) block 156 comprising N_{TPC} bits per slot, a transport format combination indicator (TFCI) block 158 comprising N_{TFCI} bits per slot and a pilot block 162 comprising Nₚᵢₗₒₜ bits per slot.

Unlike the pilot bits 162 which are known a priori, that is, they are known when received by a receiver, the TPC bits 156 may be known or unknown when they are received. The term “a priori” means “formed or conceived beforehand.” The phrase “not known” means that when some or all of the TPC bits are received at the receiver, the receiver cannot determine their actual values, and may need to determine the quality of the channel in order to determine whether the TPC bits are valid or not. Accordingly, various embodiments of the invention utilize channel quality to determine whether the TPC bits are valid or invalid.

In an embodiment of the invention, the quality of the downlink control channel transmitted with the downlink dedicated physical channel (DPCH) may be determined. Within one downlink DPCH, dedicated data may be transmitted in time-multiplex manner with control information. The control information may comprise pilot bits, transport format combination indicator (TFCI) bits and transmit power control (TPC) bits.

The user equipment 120 may be enabled to estimate the quality of reception of the TPC bits. The user equipment 120 may be, for example, a handheld phone or a card in a laptop computer, for example. If the TPC bits are received under reliable channel conditions, they may be demodulated correctly by the user equipment 120 which in turn may detect correctly the power control commands sent down by the serving radio link, and adjust its transmit power appropriately, thereby avoiding interference. On the other hand, if the TPC bits are received under poor channel conditions, the TPC commands may be decoded incorrectly by the user equipment 120 which in turn may be transmitting inappropriate transmit power levels, creating undesirable interference and limiting the system capacity.

In order to ensure proper functioning of the system, the user equipment 120 may be configured to turn OFF or disable its transmitter circuitry in the radio 146 when the determined channel condition of the TPC bits is below a first channel condition threshold and turning the user equipment's transmitter circuitry in the radio 146 back ON or enable the user equipment's transmitter circuitry in the radio 146 when the determined channel condition of the TPC bits is above a second channel condition threshold. The TPC bits are not known when they are received unlike other control information, which is known a priori. The conventional methods of computing a signal-to-noise ratio (SNR) metric based on multiplying the received signal by an a priori known sequence may not be used here.

FIG. 1C is a graph illustrating the effect of a sign metric as an indicator of the quality of received signals on the DPCH, in accordance with an embodiment of the invention. Referring to FIG. 1C, there is shown a probability of error (Pₑ) waveform 182 and a probability of error with different signs (P_{diff.sign}) waveform 184 plotted against the signal to nose ratio (SNR) per TPC bit.

The bit error rate (BER) of the received TPC bits may be related to the probability of receiving the TPC bits with different signs P_{diff.sign}. By design, the TPC bit field in a given slot may either comprise all ones, or all minus ones or all TPC bits are transmitted with the same sign. If the TPC field is received with bits having a different polarity, it may be inferred that the TPC bits are received with some probability of error. In an additive white gaussian noise (AWGN) channel, the BER of the TPC bits may be expressed according to the following equation:

$${P}_{e} = \frac{1}{2} erfc ( \sqrt{\frac{{E}_{b}}{{N}_{0}}} ) \qquad ( 1. )$$

where E_{b}/N₀ is the SNR per bit.

The TPC bit field may be composed of 2 bits, for example. The probability of receiving TPC bit 1 and 2 with different polarity may be equal to the probability of receiving the TPC field as [−1,1] or [1,−1]. This probability may be expressed according to the following equation:
P_{diff.sign}=2·Pₑ·(1−Pₑ) (2.)
The graph 180 illustrates that the two variables Pₑ 182 and P_{diff.sign} 184 have a correlated behaviour versus SNR, hence the knowledge of P_{diff.sign} offers reliable insight on the quality of reception of the TPC bits.

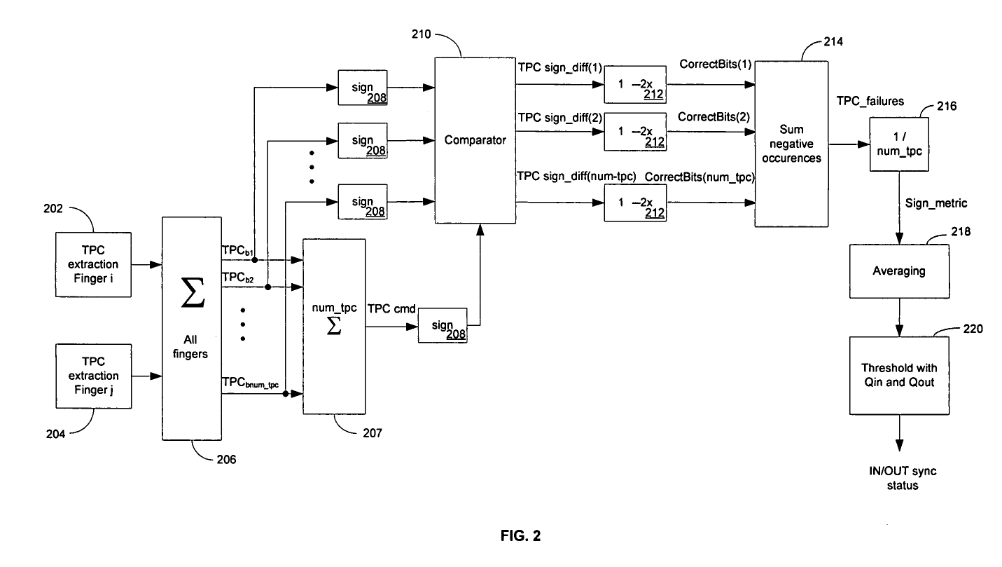

FIG. 2 is a block diagram illustrating one embodiment of the determination of a transmit power control (TPC) sign metric per radio link set in a WCDMA network, in accordance with an embodiment of the invention. Referring to FIG. 2, there is shown a plurality of TPC extraction fingers, for example, TPC extraction finger i 202 and TPC extraction finger j 204, a plurality of summing blocks 206 and 207, a plurality of sign detector blocks 208, a comparator block 210, a plurality of function blocks 212, a sum negative occurrences block 214, a divider block 216, an averaging block 218 and a threshold detector block 220.

A TPC sign metric may be computed corresponding to the TPC bits arriving from a given radio link (RL) set, indexed by k. A receiver technique that uses several baseband correlators to individually process several signal multipath components, for example, a rake receiver may be utilized. The correlator outputs also known as fingers may be combined to achieve improved communications reliability and performance. In a multipath-fading environment, with a receiver structure, for example, a RAKE or cluster processor (CPP) assigns fingers to the multiple received paths, for example, TPC extraction finger i 202 and TPC extraction finger j 204. The received TPC bits are summed over all fingers belonging to the same radio link (RL) set by the summing block 206. At each slot, a set of num_tpc TPC bits may be obtained and denoted as
{TPC_{b1}(k),TPC_{b2}(k), . . . , TPC_{bnum}_{_{—}}_{tpc}(k)}
where k is index of the RL set and num_tpc is the number of TPC bits per slot.

The corresponding TPC command may be generated by summing of all TPC bits by the summing block 207 according to the following equation:

$${TPC}_{cmd} ( k ) = {\sum }_{i = 1}^{num\_tpc} {TPC}_{bi} ( k )$$

The sign of each TPC bit detected by the sign detector blocks 208 may be then compared to the sign of the TPC command by the comparator block 210.
TPC_sign_diff(i,k)=(sign(TPC_{bi}(k)) [symbol] sign(TP_{cmd}(k)), i=1, . . . num_tpc

The value of TPC_sign_diff(i,k) may be equal to 0 if there is a sign agreement; otherwise it may be equal to 1.

A variable denoted by CorrectBits may be computed utilizing the plurality of function blocks 212 according to the following equation:
CorrectBits(i,k)=1−2·TPC_sign_diff(i,k), i=1, . . . num_tpc

The number of sign disagreements, or equivalently TPC failures, over the num_tpc bits may be calculated by the sum negative occurrences block 214 according to the following algorithm:

```
TPC_failures(k) = 0
for i = 1,...,num_tpc
{
    if (CorrectBits(i,k) ≦ 0)
    TPC_failures(k) = TPC_failures(k) + 1;
}
```

The sign metric for RL set k updated every slot may be calculated by the divider block 216 according to the following equation:

$$sign\_metric ( k ) = \frac{TPC\_failures ( k )}{num\_tpc}$$

The generated sign metric sign_metric (k) may be averaged over a given time window by the averaging block 218 to generate sign_metric_avg (k). An integrate-and-dump method, or an IIR filter may be utilized to carry out the averaging operation, for example.

The averaged sign metric, sign_metric_avg (k) may be compared to predefined thresholds by the threshold detector block 220. The user equipment 120 (FIG. 1A) turns off its transmitter when the determined channel condition specified by sign_metric_avg is above a first channel condition threshold, denoted by Qout. When such a condition is detected, the user equipment 120 is said to be in an “out-of-sync” status. The user equipment 120 turns its transmitter back on when the determined channel condition specified by sign_metric_avg is below a second channel condition threshold, denoted by Qin. When such a condition is detected, the user equipment 120 is said to be in an “in-sync” status.

When only a single RL set is active, one metric is obtained for all embodiments, namely sign_metric_avg. A thresholding operation may be carried by initializing the user equipment's 120 sync-status to, for example, “in-sync”, or Sync_status=1.
If Sign_metric_avg>Qout
   Sync_status=0 an “out-of-sync” status may be detected
Else if Sign_metric_avg<Qin
   Sync_status=1 an “in-sync” status may be detected

Qin and Qout may be chosen such that the user equipment 120 enters into “in-sync” state or “out-of-sync” state when the reception of the TPC bits reaches a certain quality level. For example, Qout may be chosen such that it corresponds to a channel quality where the TPC command error rate is around 30%, for example. Similarly Qin may be chosen such that it corresponds to a channel quality where the TPC command error rate is around 20%, for example.

Qin and Qout may be a function of the number of TPC bits per slot (num_tpc). There is a different pair of values of (Qin, Qout) for each possible num_tpc value. In another embodiment of the invention, by reducing to a 2 bits step, the invention requires only one pair of (Qin, Qout) value, valid for all possible num_tpc values.

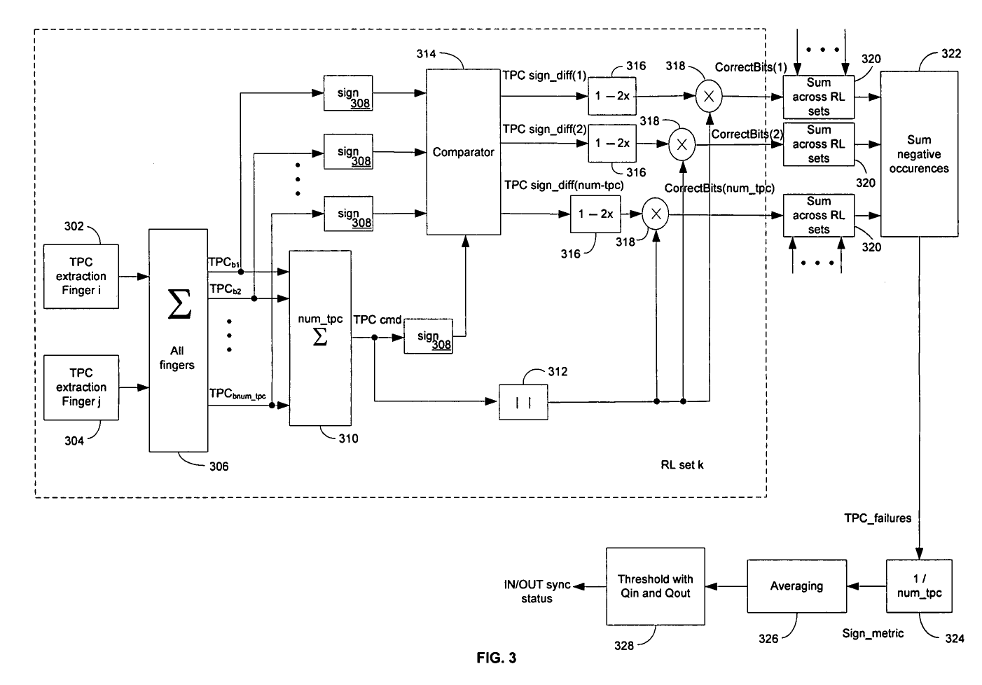

FIG. 3 is a block diagram illustrating another embodiment of the determination of a transmit power control (TPC) sign metric for a plurality of radio link sets in a WCDMA network, in accordance with an embodiment of the invention. Referring to FIG. 3, there is shown a plurality of TPC extraction fingers, for example, TPC extraction finger i 302 and TPC extraction finger j 304, a plurality of summing blocks 306 and 310, a plurality of sign detector blocks 308, an absolute function block 312, a comparator block 314, and a plurality of function blocks 316. The TPC extraction block may further comprise a plurality of multiplier blocks 318, a plurality of sum across RL sets blocks 320, a sum negative occurrences block 322, a divider block 324, an averaging block 326 and a threshold detector block 328.

A TPC sign metric may be computed corresponding to the TPC bits arriving from a given radio link (RL) set, indexed by k. In a multipath-fading environment, with a receiver structure, for example, a RAKE or cluster processor (CPP) assigns fingers to the multiple received paths, for example, TPC extraction finger i 302 and TPC extraction finger j 304. U.S. application Ser. No. 11/173,871 (Attorney Docket No. 16202US02) filed Jun. 30, 2005, provides a detailed description of a rake receiver and a CPP, and is hereby incorporated by reference in its entirety.

The received TPC bits may be summed over all fingers belonging to the same radio link (RL) set by the summing block 306. At each slot, a set of num_tpc TPC bits may be obtained and denoted as
{TPC_{b1}(k),TPC_{b2}(k), . . . , TPC_{bnum}_{_{—}}_{tpc}(k)}
where k is index of the RL set and num_tpc is the number of TPC bits per slot.

The corresponding TPC command may be generated by summing the TPC bits by the summing block 310 according to the following equation:

$${TPC}_{cmd} ( k ) = {\sum }_{i = 1}^{num\_tpc} {TPC}_{bi} ( k )$$

The sign of each TPC bit detected by the sign detector blocks 308 may be then compared to the sign of the TPC command by the comparator block 314.
TPC_sign dff(i,k)=(sign (TPC_{bi}(k)) [symbol] sign(TPC_{cmd}(k)), i=1, . . . , num_tpc

The value of TPC_sign_diff(i,k) may be equal to 0 if there is a sign agreement; otherwise it may be equal to 1.

A unique sign metric may be computed across active RL sets by computing a weighted combination of the contributions from the RL sets. A variable denoted by CorrectBits may be computed utilizing the plurality of function blocks 316, the plurality of multiplier blocks 318 and the absolute function block 312 according to the following equation:
CorrectBits (i,k)=|TPC_{cmd}(k)|·(1−2·TPC_sign_dff(i,k)), i=1, . . . , num_tpc

The variable CorrectBits is a weighted value of the sign indicator indicated by the following:
(1−2*TPC_sign_diff)

This weight may be introduced to combine the contribution from various RL sets into an overall value. In a scenario comprising multiple RL sets, where each undergoes a different radio channel condition, the TPC bits from the various RL sets may arrive at the receiver unit with different SNRs, and may have a different TPC BER across RL sets. The overall TPC BER at the receiver may be a weighted combination of the individual TPC BER associated with each active RL set. The present embodiment uses the absolute value of the TPC command as an indicator of the SNR for a given RL set. The higher the SNR for a given RL set, the higher the absolute value of the TPC command. The RL sets with higher SNR contribute more strongly to the final sign metric than another RL set with a smaller SNR.

The variable CorrectBits may be then accumulated over the number of RL sets utilizing the plurality of sum across RL sets blocks 320 according to the following equation:

$$CorrectBits\_sum ( i ) = {\sum }_{k} CorrectBits ( i , k )$$

The number of sign disagreements, or equivalently TPC failures, over the num_tpc bits may be calculated by the sum negative occurrences block 322 according to the following algorithm:

```
TPC_failures = 0
for i = 1,...,num_tpc
{
    if (CorrectBits_sum(i) ≦ 0)
    TPC_failures = TPC_failures + 1;
}
```

The sign metric for RL set k updated every slot may be calculated by the divider block 324 according to the following equation:

$$sign\_metric ( k ) = \frac{TPC\_failures ( k )}{num\_tpc}$$

The generated sign metric sign_metric (k) may be averaged over a given time window by the averaging block 326 to generate sign_metric_avg (k). In an exemplary embodiment of the invention, an integrate-and-dump method, or an IIR filter may be utilized to carry out the averaging operation.

The averaged sign metric, sign_metric_avg (k) may be compared to predefined thresholds by the threshold detector block 328. The user equipment 120 (FIG. 1A) may turn OFF its transmitter when the determined channel condition specified by sign_metric_avg is above a first channel condition threshold, denoted by Qout. When such a condition is detected, the user equipment 120 may be said to be in an “out-of-sync” status. The user equipment 120 may turn ON its transmitter again when the determined channel condition specified by sign_metric_avg may be below a second channel condition threshold, denoted by Qin. When such a condition is detected, the user equipment 120 may be said to be in an “in-sync” status.

When a set of K RL sets are active simultaneously, a total of K metrics sign_metric_avg (k) is obtained for k=1 . . . K. The information derived from the RL sets may be combined in order to determine a unique “in-sync” or “out-of-sync” status for the user equipment 120. There may be one sync status at the user equipment 120, regardless of the number of RL sets that are active. The metrics sign_metric_avg (k) may be individually compared to thresholds Qin and Qout such that a variable Sync_status (k) may be obtained for each RL set. In one embodiment of the invention, if and only if at least one out of K Sync_status (k) is “in-sync”, the Sync_status may be “in-sync”, otherwise the Sync_status may be “out-of-sync”.

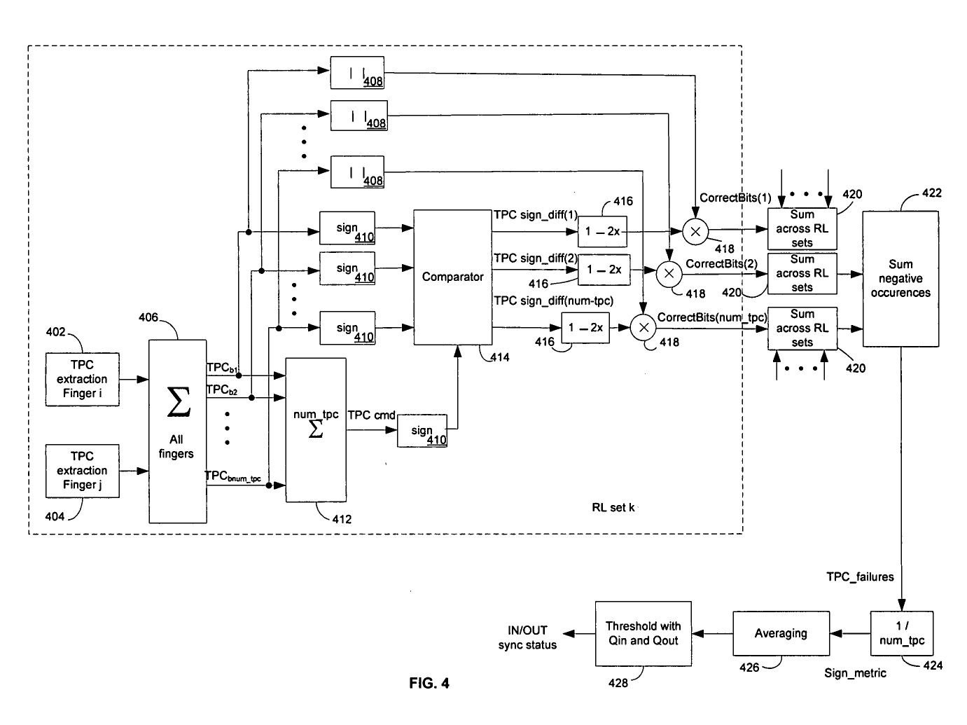

FIG. 4 is a block diagram illustrating another embodiment of the determination of a transmit power control (TPC) sign metric for a plurality of radio link sets in a WCDMA network, in accordance with an embodiment of the invention. Referring to FIG. 4, the determination of a transmit power control (TPC) sign metric for a plurality of radio link sets in a WCDMA network may be substantially as described in FIG. 3. A unique sign metric may be computed across active RL sets by computing a weighted combination of the contributions from the RL sets. A variable denoted by CorrectBits may be computed utilizing the plurality of function blocks 416, the plurality of multiplier blocks 418, and the plurality of absolute function blocks 408 according to the following equation:
CorrectBits(i,k)=|TPC_{b}_{ᵢ}(k)|·(1−2·TPC_sign_diff(i,k)), i=1, . . . num_tpc
The variable CorrectBits is a weighted value of the sign indicator, which may be indicated by the following:
(1−2*TPC_Sign_diff)

This weight may be introduced to combine the contribution from various RL sets into an overall value. In a scenario with multiple RL sets, where each undergoes a different radio channel condition, the TPC bits from the various RL sets may arrive at the receiver unit with different SNRs, and may have a different TPC BER across RL sets. The overall TPC BER at the receiver may be a weighted combination of the individual TPC BER associated with each active RL set. The present embodiment of the invention may utilize the absolute value of the TPC bit as an indicator of the SNR for a given RL set. The higher the SNR for a given RL set, the higher the absolute value of the TPC bit. The RL sets with higher SNR may contribute more strongly to the final sign metric than another RL sets with a smaller SNR.

The variable CorrectBits may be then accumulated over the number of RL sets utilizing the plurality of sum across RL sets blocks 420 according to the following equation:

$$CorrectBits\_sum ( i ) = {\sum }_{k} CorrectBits ( i , k )$$

The number of sign disagreements, or equivalently TPC failures, over the num_tpc bits may be calculated by the sum negative occurrences block 422 according to the following algorithm:

```
TPC_failures = 0
for i = 1,...,num_tpc
{
    if (CorrectBits_sum(i) ≦ 0)
    TPC_failures = TPC_failures + 1;
}
```

The sign metric for RL set k updated every slot may be calculated by the divider block 424 according to the following equation:

$$sign\_metric ( k ) = \frac{TPC\_failures ( k )}{num\_tpc}$$

The generated sign metric sign_metric (k) may be averaged over a given time window by the averaging block 426 to generate sign_metric_avg (k). In an exemplary embodiment of the invention, an integrate-and-dump method, or an IIR filter may be utilized to carry out the averaging operation.

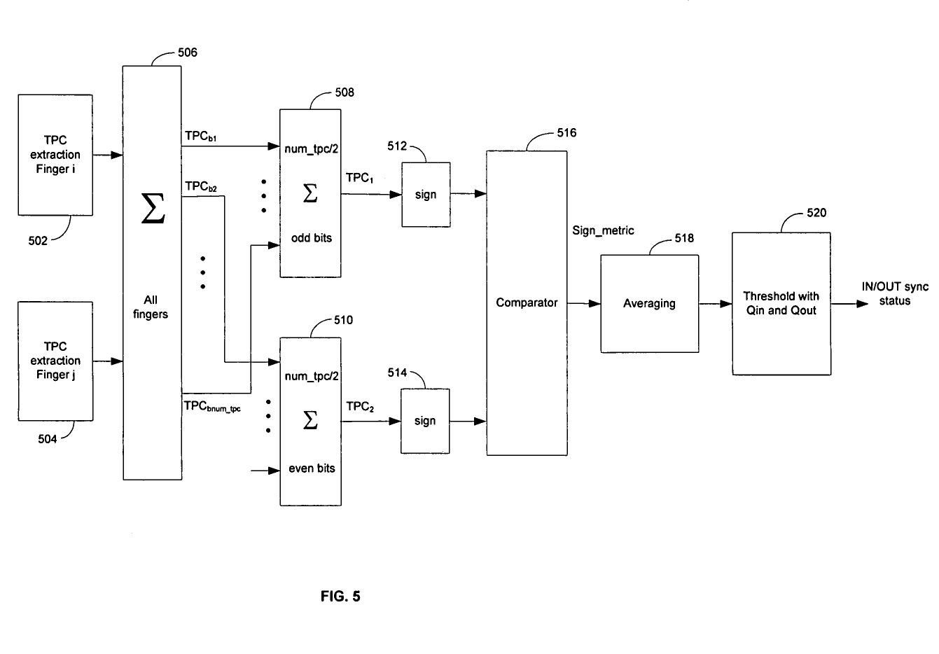

FIG. 5 is a block diagram illustrating another embodiment of the determination of a transmit power control (TPC) sign metric per radio link set in a WCDMA network, in accordance with an embodiment of the invention. Referring to FIG. 5, there is shown a plurality of TPC extraction fingers, for example, TPC extraction finger i 502 and TPC extraction finger j 504, a plurality of summing blocks 506, 508 and 510, a plurality of sign detector blocks 512 and 514, a comparator block 516, an averaging block 518 and a threshold detector block 520.

A TPC sign metric may be computed corresponding to the TPC bits arriving from a given radio link (RL) set, indexed by k. In a multipath-fading environment, with a receiver structure, for example, a RAKE or cluster processor (CPP) assigns fingers to the multiple received paths, for example, TPC extraction finger i 502 and TPC extraction finger j 504. The received TPC bits are summed over all fingers belonging to the same radio link (RL) set by the summing block 506. At each slot, a set of num_tpc TPC bits may be obtained and denoted as
{TPC_{b1}(k),TPC_{b2}(k), . . . , TPC_{bnum}_{_{—}}_{tpc}(k)}
where k is index of the RL set and num_tpc is the number of TPC bits per slot.

This embodiment of the invention compares the sign of each bit against each other. For slot formats where num_tpc>2, the algorithm first combines the bits together such that it reduces the number of bits to 2. The reduction to 2 bits may be achieved by the summing blocks 508 and 510 according to the following equations:

$${TPC}_{1} ( k ) = {\sum }_{i = 1 , 3 , ⋯}^{num\_tpc} {TPC}_{bi} ( k )$$

summation over odd-indexed bits

$${TPC}_{2} ( k ) = {\sum }_{i = 2 , 4 , ⋯}^{num\_tpc} {TPC}_{bi} ( k )$$

summation over even-indexed bits

The sign of TPC bit 1 and TPC bit 2 may be detected by the sign detector blocks 512 and 514 and compared against each other by the comparator block 516, yielding the sign metric according to the following equation:
sign_metric(k)=(sign(TPC₁(k)) [symbol] sign(TPC₂(k)))

The value of sign_metric(k) may be equal to 0 if there is a sign agreement, otherwise it may be equal to 1. The generated sign metric sign_metric (k) may be averaged over a given time window by the averaging block 518 to generate sign_metric_avg (k).

The averaged sign metric, sign_metric_avg (k) may be compared to predefined thresholds by the threshold detector block 220. The user equipment 120 (FIG. 1A) may turn OFF its transmitter when the determined channel condition specified by sign_metric_avg is above a first channel condition threshold, denoted by Qout. When such a condition is detected, the user equipment 120 is said to be in an “out-of-sync” status. The user equipment 120 may its transmitter back ON when the determined channel condition specified by sign_metric_avg is below a second channel condition threshold, denoted by Qin. When such a condition is detected, the user equipment 120 is said to be in an “in-sync” status.

When a single RL set is active, one metric may be obtained for various embodiments, namely sign_metric_avg. In accordance with an embodiment of the invention, a thresholding operation may be carried by initializing the user equipment's 120 sync-status to, for example, “in-sync”, or Sync_status=1.
If Sign_metric_avg>Qout
   Sync_status=0, an “out-of-sync” status may be detected
Else if Sign_metric_avg<Qin
   Sync_status=1, an “in-sync” status may be detected

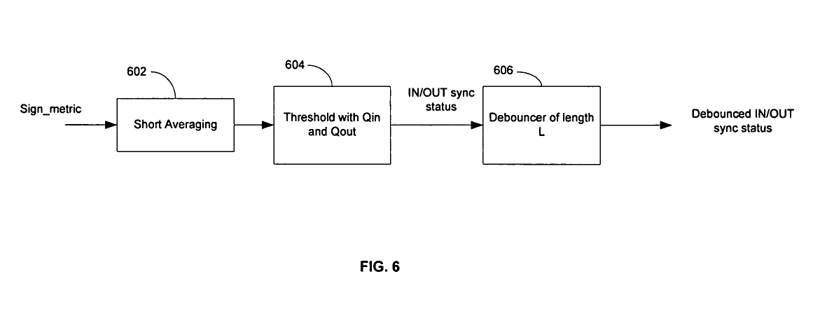

FIG. 6 is a block diagram illustrating a method for avoiding bouncing between in-sync and out-of-sync states, in accordance with an embodiment of the invention. Referring to FIG. 6, there is shown an averaging filter block 602, a threshold detector 604 and a debouncer block 606.

The debouncer block 606 may comprise suitable logic, circuitry and/or code that may be enabled to prevent the sync status to bounce or oscillate too often between in-sync and out-of-sync state. In an embodiment of the invention, the length of the averaging filter block 602 may be chosen to be long enough such that the variance of the averaged sign-metric is small. The variance is a function of the channel variation over time measured by Doppler frequency, which is an inverse function of the channel coherence time. The channel coherence time corresponds to a time period within which two observations of the channel are highly correlated. In order to ensure a small variance of the metric, the length of the averaging filter should be larger than the channel coherence time.

In another embodiment of the invention, the length of the averaging filter block 602 may be chosen to be shorter than the channel coherence time. The sign metric varies widely with the channel and the variable Sync_status oscillates rapidly between in-sync and out-of-sync. The variable Sync-Status may be passed through a debouncer block 606 of length L. The debouncer block 606 may be enabled to collect statistics of sync-status over a given period of time by keeping in memory the last L realizations of Sync-status. It may be implemented as a sliding window of length L, updated at the same rate as Sync_status, for example, once per slot. The output of the debouncer block 606, denoted by Sync_status_deb, may be “in-sync” if and only if at least X % of the last L realizations are “in-sync”. Similarly, the output of the debouncer may be “out-of-sync” if and only if at least Y % of the last L realizations are “out-of-sync”. X and Y may be chosen, for example, X=Y=90. The values of Qin and Qout may be chosen to be equal and correspond to a TPC command error rate between 20 and 30%, for example, 25%.

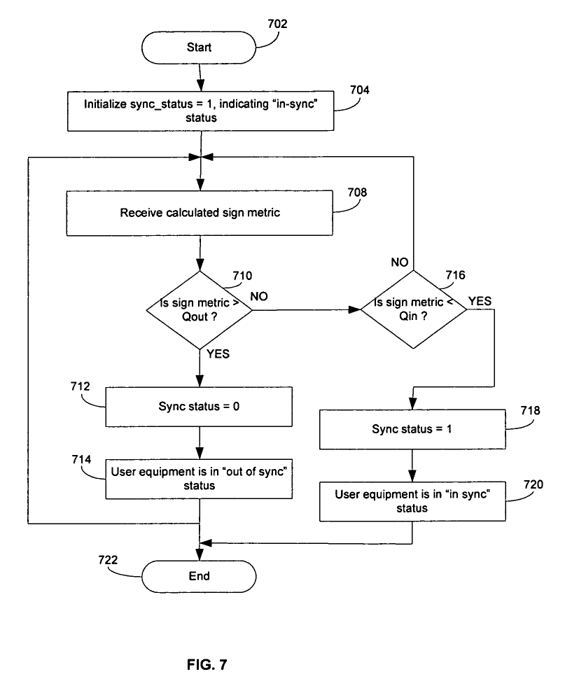

FIG. 7 is a flowchart illustrating exemplary steps for synchronization procedures in a WCDMA network based on a sign metric, in accordance with an embodiment of the invention. Referring to FIG. 7, exemplary steps may begin at step 702. In step 704, the sync status of the user equipment 120 may be initialized to 1, for example, indicating an “in-sync” status. In step 708, the calculated sign metric for a downlink dedicated physical channel (DPCH) 102 (FIG. 1B) based on a plurality of transmit power control (TPC) bits 156 received via the DPCH 102, where the TPC bits are not known when they are received and the sign metric specifies an error associated with the plurality of TPC bits may be received.

In step 710, it may be determined whether the estimated sign metric is above a certain threshold, Qout. If the estimated sign metric is above a certain threshold, Qout, control passes to step 712. In step 712, the sync status of the user equipment 120 is initialized to 0. In step 714, the user equipment 120 is indicated to be in “out of sync” status. Control passes to end step 722. If the estimated sign metric is not above a certain threshold, Qout, control passes to step 716. In step 716, it may be determined whether the estimated sign metric is below a certain threshold, Qin. If the estimated sign metric is below a certain threshold, Qin, control passes to step 718. In step 718, the sync status of the user equipment 120 is initialized to 1. In step 720, the user equipment 120 is indicated to be in “in sync” status. Control passes to end step 722.

In accordance with an embodiment of the invention, a method and system for synchronization procedures in a WCDMA network based on sign metric may comprise circuitry that enables calculation of a sign metric for a downlink dedicated physical channel (DPCH) 102 based on a plurality of transmit power control (TPC) bits 156 received via the DPCH 102, where the TPC bits are not known when they are received and the sign metric specifies an error associated with the plurality of TPC bits. The user equipment 120 may be enabled to control transmit circuitry within the radio 146 based on the calculated sign metric. The user equipment 120 may enabled to disable transmit circuitry within the radio 146 if the calculated sign metric of the plurality of TPC bits 156 is above a first channel threshold, Qout.

The user equipment 120 may enable its transmit circuitry within the radio 146 if the calculated sign metric of the plurality of TPC bits 156 is below a second channel threshold, Qin. The user equipment 120 may be enabled to estimate the quality of reception of the TPC bits. The user equipment 120 may be, for example, a handheld phone or a card in a laptop computer, for example. If the TPC bits are received under reliable channel conditions, they may be demodulated correctly, and the user equipment 120 may detect correctly the commands sent down by the serving radio link, and adjust its transmit power appropriately, thereby avoiding interference.

The summing block 207 may enable summation of portions of the plurality of TPC bits received via a plurality of multipaths over a downlink dedicated physical channel (DPCH) to generate a TPC command. The corresponding TPC command may be generated by summing of all TPC bits by the summing block 207 according to the following equation:

$${TPC}_{cmd} ( k ) = {\sum }_{i = 1}^{num\_tpc} {TPC}_{bi} ( k )$$

The user equipment 120 may enable calculation of a variable TPC_sign_diff(i,k) based on the comparison of the sign of each of the plurality of TPC bits with the sign of the TPC command. The sign of each TPC bit detected by the sign detector blocks 208 may be compared to the sign of the TPC command by the comparator block 210.
TPC_sign_dff(i,k)=sign(TPC_{b1}(k)) [symbol] sign(TPC_{cmd}))), i=1, . . . , num_tpc
The value of TPC_sign_diff(i,k) may be equal to 0 if there is a sign agreement; otherwise it may be equal to 1.

The user equipment 120 may enable calculation of a weighted sign indicator denoted by CorrectBits utilizing the plurality of function blocks 212 according to the following equation:
CorrectBits(i,k)=1−2·TPC_sign_dff(i,k), i=1, . . . , num_tpc

The user equipment 120 may enable calculation of the number of sign disagreements, or equivalently TPC failures, over the num_tpc bits utilizing the sum negative occurrences block 214 according to the following algorithm:

```
TPC_failures(k) = 0
for i = 1,...,num_tpc
{
    if (CorrectBits(i,k) ≦ 0)
    TPC_failures(k) = TPC_failures(k) + 1;
}
```

The user equipment 120 may comprise circuitry that enables calculation of the sign metric of the DPCH based on the calculated number of TPC failures between the sign of each of the plurality of TPC bits with the sign of the TPC command. The sign metric for RL set k updated every slot may be calculated by the divider block 216 according to the following equation:

$$sign\_metric ( k ) = \frac{TPC\_failures ( k )}{num\_tpc}$$

The weighted sign indicator may include the calculation of a scalar weight. The scalar weight may be either one of: scalar unity, absolute value of the TPC command or absolute value of each of the TPC bit. The calculation of the sign metric comprises of calculating a norm of the number of TPC failures by dividing the number of TPC failures by a number of the plurality of TPC bits per slot of the DPCH.

The generated sign metric sign_metric (k) may be averaged over a given time window by the averaging block 218 to generate sign_metric_avg (k). The user equipment 120 may enable summation of portions of the plurality of TPC bits over odd indexed bits to generate a first TPC bit.

$${TPC}_{1} ( k ) = {\sum }_{i = 1 , 3 , …}^{num\_tpc} {TPC}_{bi} ( k )$$

summation over odd-indexed bits

The user equipment 120 may enable summation of portions of the plurality of TPC bits over even indexed bits to generate a second TPC bit.

$${TPC}_{2} ( k ) = {\sum }_{i = 2 , 4 , …}^{num\_tpc} {TPC}_{bi} ( k )$$

summation over even-indexed bits

The user equipment 120 may enable comparison of a sign of the generated first TPC bit and a sign of the generated second TPC bit. The user equipment 120 may comprise circuitry that enables calculation of the sign metric of the DPCH based on the comparison of the sign of the generated first TPC bit and the sign of the generated second TPC bit. The sign of TPC bit 1 and TPC bit 2 may be detected by the sign detector blocks 512 and 514 and compared against each other by the comparator block 516, yielding the sign metric according to the following equation:
sign_metric(k)=(sign(TPC₁(k)) [symbol] sign(TPC₂(k)))

The value of sign_metric (k) may be equal to 0 if is there is a sign agreement, otherwise it may be equal to 1. The generated sign metric sign_metric (k) may be averaged over a given time window by the averaging block 518 to generate sign_metric_avg (k). The system comprises circuitry that enables calculation of a sign metric of the DPCH for a plurality of multipaths by averaging a calculated sign metric of each of a plurality of radio link sets. The system comprises circuitry that enables transmit circuitry if and only if at least one of the plurality of sign metrics is below a first channel threshold.

15. The method according to claim 1, further comprising calculating said sign metric of said DPCH for a plurality of multipaths by averaging a calculated sign metric of each of a plurality of radio link sets.

15b The method according to claim 14, further comprising controlling transmit circuitry based on said plurality of sign metrics.

15c The method according to claim 14b further comprising enabling transmit circuitry if and only if at least one of said plurality of sign metrics is below a first channel threshold.

15d The method according to claim 14c further comprising disabling transmit circuitry if condition in claim 14c is not met.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for signal processing, the method comprising:
calculating a sign metric of a downlink dedicated physical channel (DPCH) based on a plurality of transmit power control (TPC) bits received via said downlink dedicated physical channel, wherein a value of at least one of said plurality of TPC bits is not known when said at least one of said plurality of TPC bits is received and said sign metric specifies an error associated with said plurality of TPC bits.

2. The method according to claim 1, further comprising controlling transmit circuitry based on said calculated sign metric.

3. The method according to claim 1, further comprising disabling transmit circuitry if said calculated sign metric of said plurality of TPC bits is above a first channel threshold.

4. The method according to claim 1, further comprising enabling transmit circuitry if said calculated sign metric of said plurality of TPC bits is below a second channel threshold.

5. The method according to claim 1, further comprising:
summing portions of said plurality of TPC bits that are received via a plurality of multipaths over said downlink dedicated physical channel to generate a TPC command; and
comparing a sign of each of said plurality of TPC bits with a sign of said generated TPC command.

6. The method according to claim 5, further comprising calculating a weighted sign indicator based on said comparison of said sign of each of said plurality of TPC bits with said sign of said TPC command.

7. The method according to claim 6, further comprising calculating a number of TPC failures between said sign of each of said plurality of TPC bits with said sign of said TPC command based on said calculated weighted sign indicator.

8. The method according to claim 7, further comprising calculating said sign metric of said DPCH based on said calculated number of TPC failures between said sign of each of said plurality of TPC bits with said sign of said TPC command.

9. The method according to claim 1, further comprising summing portions of said plurality of TPC bits over odd indexed bits to generate a first TPC bit.

10. The method according to claim 9, further comprising summing portions of said plurality of TPC bits over even indexed bits to generate a second TPC bit.

11. The method according to claim 10, further comprising comparing a sign of said generated first TPC bit and a sign of said generated second TPC bit.

12. The method according to claim 11, further comprising calculating said sign metric of said DPCH based on said comparison of said sign of said generated first TPC bit and said sign of said generated second TPC bit.

13. The method according to claim 12, further comprising averaging said calculated sign metric over a time window.

14. The method according to claim 1, further comprising calculating said sign metric of said DPCH for each of a plurality of radio link sets to determine a plurality of said sign metrics.

15. The method according to claim 14, further comprising enabling transmit circuitry if and only if at least one of said plurality of sign metrics is below a first channel threshold.

16. A system for signal processing, the system comprising:
circuitry that enables calculation of a sign metric of a downlink dedicated physical channel (DPCH) based on a plurality of transmit power control (TPC) bits received via said downlink dedicated physical channel, wherein a value of at least one of said plurality of TPC bits is not known when said at least one of said plurality of TPC bits is received and said sign metric specifies an error associated with said plurality of TPC bits.

17. The system according to claim 16, further comprising circuitry that enables controlling of transmit circuitry based on said calculated sign metric.

18. The system according to claim 16, further comprising circuitry that disables transmit circuitry if said calculated sign metric of said plurality of TPC bits is above a first channel threshold.

19. The system according to claim 16, further comprising circuitry that enables transmit circuitry if said calculated sign metric of said plurality of TPC bits is below a second channel threshold.

20. The system according to claim 16, further comprising:
circuitry that enables summation of portions of said plurality of TPC bits that are received via a plurality of multipaths over said downlink dedicated physical channel to generate a TPC command; and
circuitry that enables comparison of a sign of each of said plurality of TPC bits with a sign of said generated TPC command.

21. The system according to claim 20, further comprising circuitry that enables calculation of a weighted sign indicator based on said comparison of said sign of each of said plurality of TPC bits with said sign of said TPC command.

22. The system according to claim 21, further comprising circuitry that enables calculation of a number of TPC failures between said sign of each of said plurality of TPC bits with said sign of said TPC command based on said calculated weighted sign indicator.

23. The system according to claim 22, further comprising circuitry that enables calculation of said sign metric of said DPCH based on said calculated number of TPC failures between said sign of each of said plurality of TPC bits with said sign of said TPC command.

24. The system according to claim 16, further comprising circuitry that enables summation of portions of said plurality of TPC bits over odd indexed bits to generate a first TPC bit.

25. The system according to claim 24, further comprising circuitry that enables summation of portions of said plurality of TPC bits over even indexed bits to generate a second TPC bit.

26. The system according to claim 25, further comprising circuitry that enables comparison of a sign of said generated first TPC bit and a sign of said generated second TPC bit.

27. The system according to claim 26, further comprising circuitry that enables calculation of said sign metric of said DPCH based on said comparison of said sign of said generated first TPC bit and said sign of said generated second TPC bit.

28. The method according to claim 27, further comprising averaging said calculated sign metric over a time window.

29. The system according to claim 16, further comprising circuitry that enables calculation of said sign metric of said DPCH for a plurality of multipaths by averaging a calculated sign metric of each of a plurality of radio link sets.

30. The system according to claim 29, further comprising circuitry that enables transmit circuitry if and only if at least one of said plurality of sign metrics is below a first channel threshold.
